(19) United States
(12) Patent Application Publication
(10) Pub. No.: US 2008/0088412 A1
(43) Pub. Date: Apr. 17, 2008

(54) System and method for detecting motion of portable security module to conserve battery life

(76) Inventors: Daryl Carvis Cromer, Cary, NC (US); Howard Jeffrey Locker, Cary, NC (US); James Stephen Rutledge, Durham, NC (US); Sean Michael Ulrich, Morrisville, NC (US)

Correspondence Address: ROGITZ & ASSOCIATES, 750 B STREET, SUITE 3120, SAN DIEGO, CA, 92101, US

(21) Appl. No.: 11/540,404

(22) Filed: Sep. 28, 2006

(51) Int. Cl. G05B 19/00

(52) U.S. Cl. 340/5.64; 340/539.3; 340/5.7; 341/176

(57) ABSTRACT

A security fob periodically transmits wireless access signals that can be received by entities such as computers, buildings and the like to which access is sought. A motion detector is in the fob so that when the fob has been motionless for a threshold period non-essential components are deenergized, putting the fob in a sleep mode to conserve battery power.

### FIELD OF THE INVENTION

The present invention relates generally to conserving battery life in portable security modules such as security fobs.

### BACKGROUND OF THE INVENTION

Portable security modules, sometimes colloquially known as “key fobs”, can be carried by a person and, when the person is sufficiently close to an entity (such as a computer, a building, etc.) to which access is desired, the security module automatically interfaces with the entity to unlock it, assuming an authorized module.

As understood herein, many security modules are battery powered, and operate by periodically transmitting wireless polling signals in case the entity to which access is desired is nearby. The present invention understands that, particularly as security modules and, hence, battery power sources inside them shrink in size, power conservation in security modules is desirable.

### SUMMARY OF THE INVENTION

A security module includes a portable housing and a processor and wireless interface supported by the housing. The wireless interface is controlled by the processor to transmit wireless access signals that may carry authentication information useful for granting access to a locked entity. A battery is supported by the housing to power at least the processor and the wireless interface, and a motion detector on the housing sends a motion signal to the processor in the event that motion is sensed by the detector. If no motion signal is received by the processor for a threshold time period, the module enters a sleep mode.

In some implementations when a motion signal is received during the sleep mode, the module enters an active mode, with more components of the module being powered by the battery in the active mode than in the sleep mode. For instance, the wireless interface can be powered by the battery in the active mode and not powered by the battery in the sleep mode.

In another aspect, a computer readable medium bears instructions that can be executed by a processor of a portable security module to deenergize at least one component of the module if no motion of the module is sensed for a predetermined period, and to otherwise energize the module so that it transmits wireless access signals bearing authentication information.

In still another aspect, a system for conserving battery power in a wireless portable security module includes means for transmitting wireless access signals useful for unlocking a locked entity in an active mode, and means for, if the module has been motionless for a predetermined period, causing the module to enter a sleep mode in which less power is consumed than in the active mode.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting module in accordance with the present invention; and

FIG. 2 is a flow chart of non-limiting logic envisioned by the present invention.

### DETAILED DESCRIPTION OF THE PREFERRED EMBODIMENT

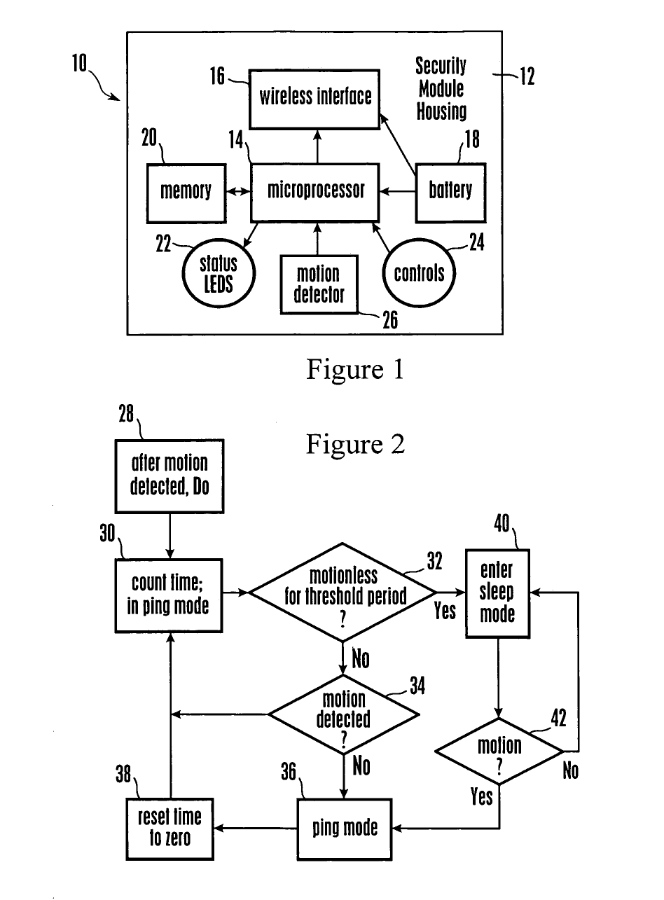

Referring initially to FIG. 1, a security module is shown, generally designated 10. The security module 10 can be embodied in non-limiting implementations by a key fob, a proximity device in general, an automatic ignition module for a vehicle, or other portable, typically hand-held security device.

Accordingly, the module 10 includes a portable lightweight housing 12 holding a processor 14. In accordance with security module principles known in the art, the processor 14 controls a wireless interface 16 to periodically transmit wireless signals which can be received by entities, such as but not limited to computers and buildings, which have complementary receivers to electronically or mechanically unlock the entities, provided satisfactory authentication information is carried in the signal transmitted by the module 10. The particular type of wireless signal is not limiting.

One or more batteries (only a single battery 18 shown for clarity of disclosure) can be in the housing 18 and can be electrically connected to various components, including, e.g., the processor 14 and wireless interface 16, to power the components. Security information to be transmitted, as well as code implementing the present logic, can be stored in a computer readable medium such as but not limited to a memory 20 within the housing 12 for access thereof by the processor 14.

In non-limiting implementations, status light emitting diodes (LEDs) 22 can be provided on the housing to indicate, e.g., transmission status, battery status, unlock status, etc. Also, if desired one or more user controls 24, such as user-manipulable buttons, can be provided on the housing 12.

In accordance with present principles, the housing 12 also supports a motion detector 26 that senses motion and sends a signal indicative thereof to the processor 14. Any suitable motion detector may be used, including, without limitation, accelerometers, piezoelectric-based or otherwise, etc.

Non-limiting logic executable by the processor 14 for using the motion detector 26 can be seen in FIG. 2, which is presented in flow chart format for ease of exposition, it being understood that in actual implementation the logic may be otherwise implemented, e.g., as state logic. Commencing at block 28, after a motion signal has been received from the motion detector 26, a timer, initialized at zero, is activated to count up at block 30. At this point, the module 10 is in an active, or ping, mode wherein the processor 14 controls the wireless interface 16 to transmit signals for potential reception thereof by an entity to which access is sought. The signals may contain, e.g., authentication information. In the active mode, substantially all the components in the module 10 that can be powered by the battery 18 are on, including the processor 14, the wireless interface 16, the LEDs 22, and, if it requires battery power to operate, the motion detector 26.

Decision diamond 32 is meant to indicate that the timer is monitored to determine whether a threshold period (e.g., ten seconds or some other appropriate period) has elapsed since the most recent motion signal was generated. If not, the non-limiting logic determines at decision diamond 34 whether a new motion signal has been received. If not, the logic loops back to block 30. When a new motion signal is received at decision diamond 34, the module 10 remains in the active mode at state 36, and the timer is reset to zero at block 38, with the logic then resuming the time count, now rezeroed, at block 30. As stated above, the flow chart loops shown in FIG. 2 may be, in actual implementation, logic flows or state logic or other suitable logic.

Recall that decision diamond 32 represented a possible time count of no motion exceeding the threshold period. When this occurs, the logic enters a sleep mode at state 40 until such time as the motion detector 26 once again generates a motion signal at state 42, in which case the logic assumes the active mode at block 36 and proceeds as disclosed above. In the sleep mode, less than all of the components that are energized during the active are powered on, to conserve battery life. For instance, in the sleep mode, by way of non-limiting example the wireless interface 16 and/or LEDs 22 and/or other non-essential components are not energized by the battery 18. This can be accomplished in any suitable way, such as opening switches between the battery and the non-essential components. Typically, the processor 14 and, if it requires battery power, the motion detector 26, remain energized by the battery 18 in the sleep mode, for the limited purpose of detecting motion.

While the particular SYSTEM AND METHOD FOR DETECTING MOTION OF PORTABLE SECURITY MODULE TO CONSERVE BATTERY LIFE is herein shown and described in detail, it is to be understood that the subject matter which is encompassed by the present invention is limited only by the claims.

What is claimed is:

1. A security module, comprising:
a portable housing;
at least one processor supported by the housing;
at least one wireless interface supported by the housing and controlled by the processor to transmit wireless access signals;
at least one battery supported by the housing to power at least the processor and the wireless interface; and
at least one motion detector supported by the housing and sending at least one motion signal to the processor in the event that motion is sensed by the detector, wherein
if no motion signal is received by the processor for a threshold time period, the module enters a sleep mode.

2. The module of claim 1, wherein the access signals carry authentication information useful for granting access to a locked entity.

3. The module of claim 1, wherein when a motion signal is received during the sleep mode, the module enters an active mode, more components of the module being powered by the battery in the active mode than in the sleep mode.

4. The module of claim 3, wherein at least the wireless interface is powered by the battery in the active mode and is not powered by the battery in the sleep mode.

5. A computer readable medium bearing instructions executable by a processor of a portable security module to deenergize at least one component of the module if no motion of the module is sensed for at least a predetermined period, and to otherwise energize the module so that it transmits wireless access signals bearing authentication information.

6. The medium of claim 5, wherein the module includes:
a portable housing, the processor supported by the housing;
at least one wireless interface supported by the housing and controlled by the processor to transmit the wireless access signals;
at least one battery supported by the housing to power at least the processor and the wireless interface; and
at least one motion detector supported by the housing and sending at least one motion signal to the processor if motion is sensed by the detector.

7. The medium of claim 6, wherein the access signals carry authentication information useful for granting access to a locked entity.

8. The medium of claim 6, wherein when a motion signal is received during the sleep mode, the module enters an active mode, more components of the module being powered by the battery in the active mode than in the sleep mode.

9. The medium of claim 8, wherein at least the wireless interface is powered by the battery in the active mode and is not powered by the battery in the sleep mode.

10. A system for conserving battery power in a wireless portable security module, comprising:
means for transmitting wireless access signals useful for unlocking at least one locked entity in an active mode; and
means for, if the module has been motionless for a predetermined period, causing the module to enter a sleep mode in which less power is consumed than in the active mode.

11. The system of claim 10, wherein the means for transmitting includes a wireless interface.

12. The system of claim 11, wherein the means for causing includes a processor.

13. The system of claim 12, wherein the module further comprises:
a portable housing, the processor and interface being supported by the housing;
at least one battery supported by the housing to power at least the processor and the wireless interface; and
at least one motion detector supported by the housing and sending at least one motion signal to the processor if motion is sensed by the detector.

14. The system of claim 13, wherein when a motion signal is received during the sleep mode, the module enters an active mode, more components of the module being powered by the battery in the active mode than in the sleep mode.

15. The system of claim 14, wherein at least the wireless interface is powered by the battery in the active mode and is not powered by the battery in the sleep mode.
